(19) United States
(12) Patent Application Publication
(10) Pub. No.: US 2026/0295990 A1
(43) Pub. Date: Oct. 1, 2026

(54) INK CUP ASSEMBLY WITH NON-MAGNETIC FORCE MECHANISM

(71) Applicant: Acushnet Company, Fairhaven, MA (US)

(72) Inventors: Brian Couto, Dartmouth, MA (US); Michael J. Toupin, Fall River, MA (US)

(73) Assignee: Acushnet Company, Fairhaven, MA (US)

(21) Appl. No.: 19/093,366

(22) Filed: Mar. 28, 2025

(51) Int. Cl. B41F 31/18; A63B 45/02; B41F 17/00; B41F 17/34; B41M 1/40

(52) U.S. Cl. CPC B41F 31/18; A63B 45/02; B41F 17/001; B41F 17/34; B41M 1/40

(57) ABSTRACT

A printing system has a printing plate, an ink cup assembly, and a movement mechanism. The printing plate has a surface and a depression formed in the surface for receiving ink for printing on a golf ball. The ink cup assembly is configured to contact the surface of the printing plate and supply the depression with ink. The ink cup assembly has an ink holder having an open cavity for receiving ink, and a force mechanism configured to hold the ink cup assembly in contact with the surface of the printing plate. The force mechanism has at least one spring configured to apply a predetermined force to a pressure surface of the ink holder. The movement mechanism moves the ink cup assembly between a first position on the printing plate and a second position on the printing plate while the ink cup assembly maintains contact with the surface of the printing plate via the at least one spring.

### FIELD OF THE INVENTION

The present disclosure relates to a printings system, and more particularly, to an ink cup assembly with a non-magnetic force mechanism.

### BACKGROUND OF THE INVENTION

Indicia is often added to the surface of golf balls using pad printing. Pad printing is a process in which ink is transferred from depressions in a printing plate (sometimes referred to as a printing cliché) to a printing pad. The printing pad applies the ink to the golf ball. In order to quickly repeat the printing process, the depressions are automatically refilled after the ink is transferred to the pad. This process often includes sliding an inverted ink cup against the printing plate to a position over the depressions and then sliding the ink cup back to a starting position, leaving ink only in the depressions.

A force mechanism applies a force to keep the ink cup sealed against the printing plate and to enable a blade portion to scrape the ink off of the surface of the plate. If the force that presses the ink cup against the printing plate is not correctly calibrated, the ink cup may be unable to slide (e.g., when the force is too strong) or the mechanism may leave residual ink on surface parts of the printing plate (e.g., when the force is not strong enough). In the latter case, ink left on the surface of the printing plate can lead to shadows, smearing, stray marks, or other printing errors. Conventional ink cups may use magnets to apply a force that holds the ink cup against the printing plate. However, there are some arrangements in which magnetic force mechanisms are not completely effective. For example, some printing plates may be at least partially made from a polymer, hindering or limiting the force that magnets alone can impart on the ink cup. The present disclosure includes an ink cup that addresses this and other issues of the prior art.

### SUMMARY OF THE INVENTION

In at least some disclosed embodiments, the present disclosure includes a printing system. The printing system includes a printing plate, an ink cup assembly, and a movement mechanism. The printing plate includes a surface and a depression formed in the surface for receiving ink for printing on a golf ball. The ink cup assembly is configured to contact the surface of the printing plate and supply the depression with ink. The ink cup assembly includes an ink holder including an open cavity for receiving ink, and a force mechanism configured to hold the ink cup assembly in contact with the surface of the printing plate. The force mechanism includes at least one spring configured to apply a predetermined force to a pressure surface of the ink holder. The movement mechanism moves the ink cup assembly between a first position on the printing plate and a second position on the printing plate while the ink cup assembly maintains contact with the surface of the printing plate. The movement mechanism includes a support structure including a counteracting surface, wherein the counteracting surface is adjacent to the pressure surface of the ink holder and the at least one spring is configured to act against the counteracting surface to apply the predetermined force to the pressure surface.

In at least some embodiments, the present disclosure also includes an ink holder, The ink holder includes a body integrally formed as one piece. The body includes a first side including an open cavity configured to receive an ink cup liner, a second, opposite side including a pressure surface, and a perimeter wall between the first and second side. The pressure surface includes a plurality of blind holes for each receiving a spring. The perimeter wall defines a height of the body that is less than 120 mm. The plurality of blind holes include at least four separate blind holes for receiving at least four separate springs, each blind hole having a depth of less than 25 mm, and being equally spaced from each other and from a center point of the body on a circle having a radius between 5 and 60 mm.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1 is a diagram of an exemplary pad printing system, consistent with disclosed embodiments;

FIG. 2 is a side view of an ink holder that may be used in conjunction with a pad printing system, consistent with disclosed embodiments;

FIG. 3 is a perspective view of a first side of the ink holder of FIG. 2;

FIG. 4 is a perspective view of a second side of the ink holder of FIG. 2; and

FIG. 5 is a side view of a pad printing system including the ink holder of FIGS. 2-4, consistent with disclosed embodiments.

### DETAILED DESCRIPTION OF THE INVENTION

Golf balls often include printed indicia at various locations on the surface. There are several printing methods for applying the indicia, including pad printing and laser jet printing, for example. Pad printing is an indirect intaglio process. Depressions are created in a flat block called “the printing plate” or pad printing cliché. The depressions are filled with ink and a smooth, resilient stamp block of silicone rubber takes up ink from the plate and transfers it to the golf ball.

For pad printing on a golf ball, ink is arranged in a pattern corresponding to the markings to be made on the ball. The pattern is made up of one or more depressions formed in the surface of the plate. The depressions are wells that hold ink therein and can be etched into the surface to match the desired appearance of the indicia (or a portion of the indicia). A pad contacts the plate and thereby receives the ink on the pad surface. The ink is then transferred from the pad to the golf ball by “stamping” (i.e., pressing) the inked pad onto the golf ball.

The printing process is quickly repeatable using machines that automatically refill the depressions in the printing plate after the ink is transferred to the pad in the previous cycle. For example, in some processes, an ink cup is filled with ink and placed against the printing plate in an inverted position. The ink cup is effectively sealed by the surface of the printing plate. A machine automatically slides the ink cup while maintaining contact with the printing plate from a position away from the depressions to a position over the depressions, thereby filling the depressions with ink from the ink cup. The machine slides the ink cup away, leaving the refilled depressions exposed for transfer to the printing pad. The ink cup may be connected to or include an integral blade that scrapes the ink over the top of the depressions as it is slid away. As a result, the ink is cleanly left only on the depressions, helping to prevent stray markings or smearing of the ink on the printing pad.

Ink cups use a force mechanism to keep the ink cup sealed against the printing plate. The force mechanism holds the ink cup against the printing plate to prevent leakage and to apply sufficient force such that the integral blade of the mechanism is capable of cleanly scraping the ink off of the surface of the printing plate (i.e., anywhere that is not a depression). For example, many ink cups use magnets to apply a force that holds the ink cup against the printing plate. There are some instances, such as situations in which the printing plate is a polymer material and is not sufficiently attracted to the magnets to provide enough force to prevent shadowing or smearing of ink on the surface of the printing plate.

The present disclosure includes an ink cup assembly with a non-magnetic force mechanism that holds the ink cup assembly against the printing plate for use in refilling depressions in the plate. The non-magnetic force mechanism is directly applied to an integrally formed ink holder body, thereby providing a compact and efficient design. The non-magnetic force mechanism may replace or supplement (i.e., be used in combination with) a magnetic force mechanism. The non-magnetic force mechanism may be particularly applicable for use with polymer printing plates. According to exemplary embodiments, the non-magnetic force mechanism may be a spring mechanism that applies a predetermined force that urges the ink cup toward the printing plate. The spring mechanism may include a plurality of springs disposed in a symmetrical pattern to apply an equally-dispersed force to a pressure surface of the ink holder.

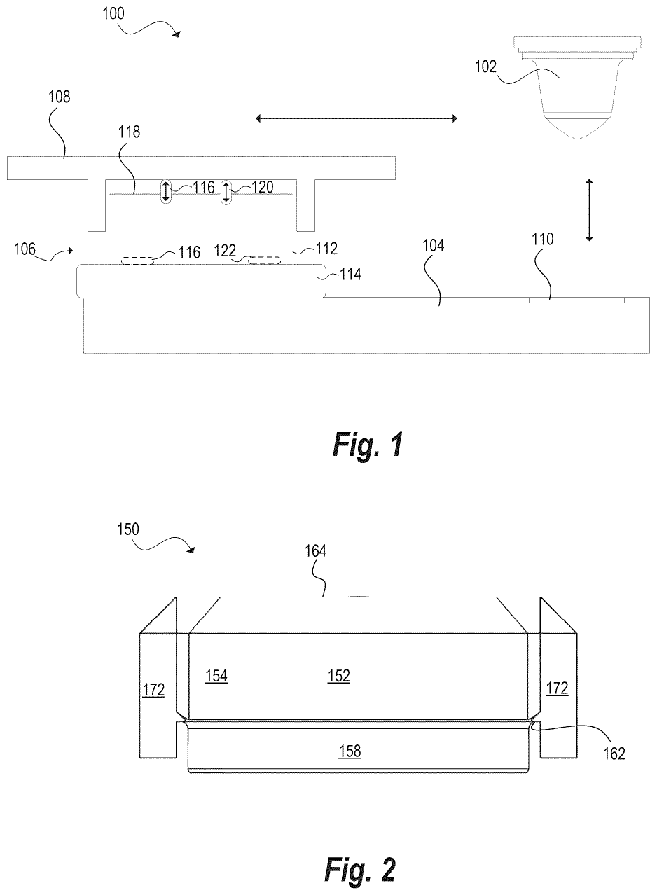

FIG. 1 is a diagram of an exemplary pad printing system 100. The printing system 100 includes a printing pad 102, a printing plate 104, an ink cup assembly 106, and a movement mechanism 108. The printing plate 104 includes depression 110 that includes a pattern that matches indicia to be applied to a golf ball. The depression(s) 110 are filled with ink that is subsequently transferred to the printing pad 102 to be applied to the golf ball. The depressions 110 may be formed in the printing plate 104 in a known manner, such as through laser etching or other engraving process.

The printing plate 104 may be a generally rectangular device with a flat surface. The printing plate 104 may be made from a suitable material that maintains the integrity of the depression 110. In an exemplary embodiment, the printing plate 104 is made of a polymer material In some embodiments, the printing plate 104 is a composite material include polymer and a magnetic material. In some embodiments, the polymer may polarized to be the magnetic material.

The ink cup assembly 106 is configured to slide from a first position on the printing plate 104 to a second position on the printing plate 104 while maintaining contact with the surface of the printing plate 104. The first position may be spaced from the depressions 110 and the second position may be directly over the depressions 110. As a result, the ink cup assembly 106 may be configured to slide on the printing plate 104 from the first position to the second position to fill the depressions 110 and slide back to the first position to expose the filled depressions 110 for transfer to the printing pad 102. The printing plate 104 may be made of a rigid material capable of being altered to customize the shape and pattern of the depressions 110 (e.g., via etching or engraving). In an exemplary embodiment, the printing plate is a polymer material capable of being laser engraved with a customized pattern to form depressions 110.

The ink cup assembly 106 includes an ink holder 112, a blade 114, a force mechanism 116, and a pressure surface 118. In an exemplary embodiment, the ink holder 112 may be an integrally-formed part for accommodating other aspects of the ink cup assembly 106. In some embodiments, the ink holder 112 may be a 3-D printed part. In other embodiments, the ink holder 112 may be a cast metal material. Other materials and methods for making the ink holder 112 are possible.

The ink holder 112 includes an open cavity. For example, the ink holder 112 may be configured to receive an ink cup liner that receives ink therein. In other embodiments, the ink holder 112 is configured to directly receive an amount of ink. The ink holder 112 may further include features for accommodating the blade 114. The blade 114 may be a rigid ring that is attached to a portion of the ink holder 112 and is configured to directly contact and interface with the printing plate 104. The blade 114 is configured to slide along the printing plate 104 while maintaining contact with the surface of the printing plate 104. The blade 114 may be a carbide steel ring configured to surround the open cavity of the ink holder 112. The blade 114 includes an edge in contact with a surface of the printing plate 104. The edge of the blade 114 scrapes ink on the surface of the printing plate 104, leaving ink only in the depressions 110.

The ink holder 112 is configured to support the force mechanism 116. The force mechanism 116 is configured to apply a force to hold the ink holder 112 against the printing plate 104 with the open cavity facing the printing plate 104. In this way, ink that is within the cavity (e.g., within a ink cup liner) is present on the printing plate 104 and can be moved into the depressions 110 through sliding movement of the ink holder 112. In an exemplary embodiment, the force mechanism 116 includes at least one spring 120. The at least one spring 120 may be seated within a blind hole formed in the pressure surface 118 of the ink cup assembly 106. The spring 120 applies a pressure to the pressure surface 118 to urge the ink holder 112 toward the printing plate 104. The spring 120 may be any type of spring capable of applying a force to the ink holder 112. For example the spring 120 is a coil spring. In other embodiments, the spring 120 is a leaf spring.

In some embodiments, the force mechanism 116 further includes at least one magnet 122. The magnet(s) 122 are attached to the ink holder 112 and configured to attract to an aspect of the printing plate 104 to hold the ink holder 112 against the printing plate 110. In some embodiments, the spring(s) 120 apply a predetermined force to effectively hold the ink cup assembly 106 against the printing plate 104 (i.e., within a predetermined force range that allows for unintrusive sliding while preventing ink leakage or shadow/smearing issues due to inadequate force). In other embodiments, this predetermined force range is achieved by a combination of the spring(s) 120 and the magnet(s) 122 (or other supplemental force mechanism).

The pressure surface 118 is configured to interact with the movement mechanism 108. The movement mechanism 108 may be a support structure that connects to the ink cup assembly 112 and is configured to move the ink cup assembly 112 on the printing plate 104. For example, the movement mechanism 108 may be a motorized arm that attaches to the ink holder 112 and is configured to slide the ink cup assembly 112 between the first position and the second position on the printing plate 104. In an exemplary embodiment, the movement mechanism 108 includes a counteracting surface that is positioned adjacent the pressure surface 108 and provides a surface for the spring(s) 120 to act against to apply a corresponding force to the ink holder 112.

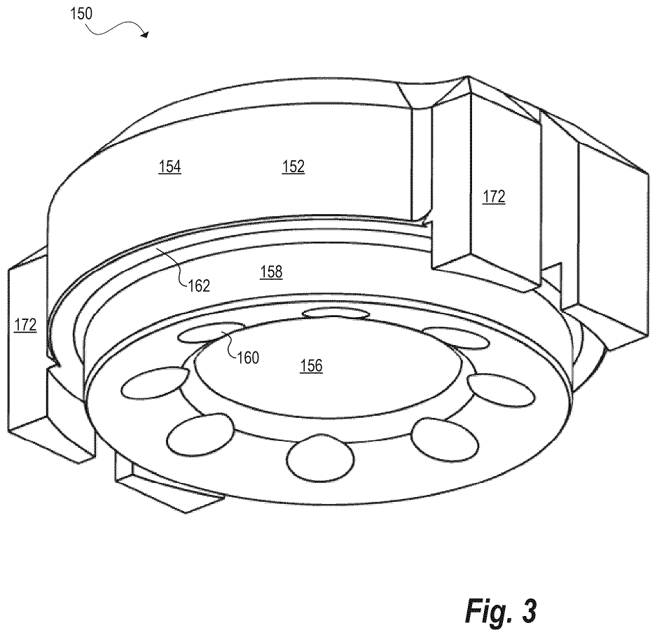

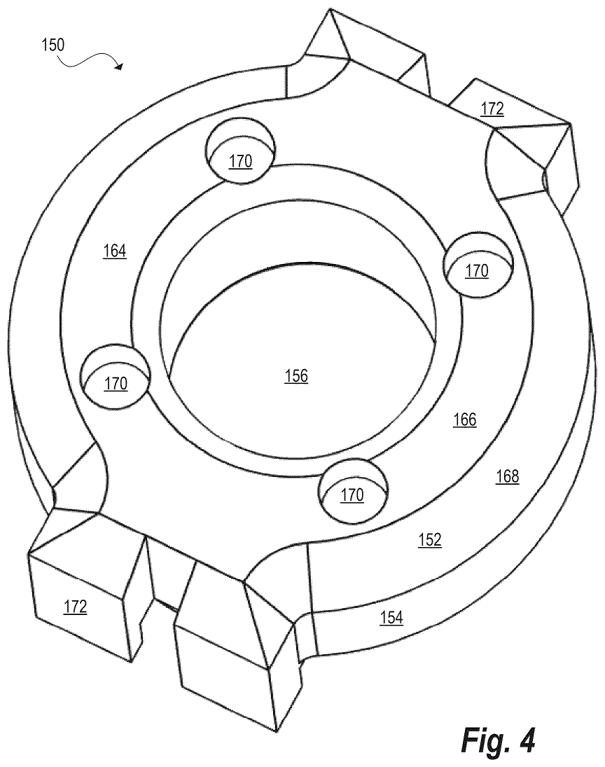

FIGS. 2-4 depict an embodiment of an ink holder 150, consistent with disclosed embodiments. The ink holder 150 may be used in a printing system to perform a repeating pad printing process on a plurality of golf balls. In an exemplary embodiment, the ink holder 150 is a single part having a body 152 that is integrally formed as one piece. The body 152 may be generally cylindrical or rectangular including a first (or bottom) side as shown in FIG. 3 and a second (or top) side as shown in FIG. 4. The ink holder 150 is effectively a single piece adapter that works directly with other components of a printing system in a compact and efficient manner. For example, the ink holder 150 includes integrally-formed features for connecting to a blade to seal against and scrape a surface of a printing plate. In some other embodiments, a blade may be an integrally-formed part of an ink holder. The ink holder 150 additionally includes integrally-formed features for receiving an ink cup liner, interacting with a force mechanism, and connecting to a movement mechanism.

FIG. 2 shows a side view of the ink holder 150 including a perimeter wall 154 that is between the first and second side and defines a height of the body 152. In exemplary embodiments, the perimeter wall 154 defines a height that is less than 120 mm. In some embodiments, the height is less than 80 mm. In other embodiments, the height is less than 40 mm.

FIG. 3 shows a first side of the ink holder 150. The first side of the ink holder 150 is the side that is configured to face a printing plate. The first side of the ink holder 150 includes an open cavity 156. The open cavity 156 is centered within the body 152 and faces away from the first side. The open cavity 156 is configured to hold ink therein. For example, the open cavity 156 may be sized and shaped to receive an ink cup liner therein. In other embodiments of an ink holder, an open cavity may be configured to directly hold ink therein.

The first side of the ink holder 150 further includes a protruding portion 158. The protruding portion 158 may be a ring-shaped feature that is integrally-formed as part of the body 152. The protruding portion 158 surrounds the open cavity 156. The open cavity 156 is centered within the protruding portion 158. The protruding portion 158 may include a plurality of individual recesses 160 formed in a surface thereof. The recesses 160 may be configured to receive and hold magnets. The magnets held therein may be a component of a force mechanism to hold down an ink cup assembly using the ink holder 150. In other embodiments, a protruding portion may be similarly shaped but without recesses for magnets, such as embodiments in which a force mechanism does not use magnetic attraction to hold down an ink cup assembly.

The first side of the ink holder 150 further includes a recessed ledge 162. The recessed ledge 162 surrounds the protruding portion 158. The recessed ledge 162 creates a surface for supporting other components that may be used in conjunction with the ink holder 150. For example, a lip of an ink cup liner may be formed to conform to the shape of the protruding portion 158 and rest on the recessed ledge 162. The recessed ledge 162 further provides a counteracting surface for a ring-shaped blade that may be fit over the protruding portion 158.

FIG. 4 shows a second side of the ink holder 150. The second side of the ink holder 150 is the side that is configured to face away from a printing plate. In the depicted embodiment, the open cavity 156 is formed as part of a through hole that extends all the way through the first and second sides of the ink holder 150. In this embodiment, an ink cup liner provides a closed end for containing ink within the ink holder 150. The second side of the ink holder 150 further includes a pressure surface 164 that faces away from the second side. The pressure surface 164 is configured such that force applied to the pressure surface 164 urges the first side of the ink holder 150 downward (e.g., toward a printing plate positioned underneath the ink holder 150).

The pressure surface 164 surrounds the open through hole of the body 152. The open through hole allows an ink cup liner to fit within a center of the ink holder 150. The pressure surface 164 being formed around the open through hole advantageously does not block a center space of the ink cup 150, as is the case with some conventional designs, and, as a result, enables the use of different sizes of ink cup liners. In other embodiments in which an open cavity is closed by the second side, the pressure surface 164 may be continuous without an opening therein. The pressure surface 164 includes a circular shape. The pressure surface 164 includes a flat portion 166. In some embodiments, the pressure surface 164 further includes a chamfered portion 168 that transitions into the perimeter wall 154 of the body 152.

The second side of the ink holder 150 includes at least one blind hole 170 formed in the pressure surface 164. The at least one blind hole 170 may be a circular channel that has a bottom (i.e., the channel does not go all the way through the body 152). The at least one blind hole 170 is configured to receive a spring as a force mechanism to urge the ink holder 150 toward a printing plate. In an exemplary embodiment, the at least one blind hole 170 includes a plurality of blind holes. For example, the ink holder 150 may include four blind holes, each configured to receive a portion of a spring. In order to evenly distribute a force applied by the plurality of springs, the blind holes 170 are equally spaced from each other and from a center point CP of the body 152. For example, each blind hole 170 may be formed on a circle having a radius of in a range of 5-60 mm. The use of multiple blind holes 170 for multiple springs, spaced on a circle, enables the ink holder 150 to have the center through hole as shown in the figures. Moreover, the disclosed configuration allows for relatively shallow blind hole depths which do not interfere with space that can be otherwise used for receiving ink. For example, in some embodiments, each blind hole 170 has a depth of less than 25 mm. In an embodiment, each blind hole 170 has a depth between 5-10 mm. In a particular embodiment, each blind hole 170 has a depth of 7.6 mm. The disclosed blind hole depths enable more precise control over the positioning of and counteracting forces applied to the ink holder 150.

The ink holder 150 further includes at least one alignment fitting 172 integrally formed as part of the perimeter wall 154 of the body 152. In the depicted embodiment, the ink holder 150 includes two alignment fittings 172 formed on opposing sides of the body 152 (these opposing “sides” are orthogonal to the direction of the opposing first and second sides of the ink holder 150). The alignment fittings 172 extend in the height direction of the body 152. The alignment fittings 172 are configured to connect the body 152 to a support structure of a movement mechanism configured to move the ink holder 150 on a printing plate. In some embodiments, the alignment fittings 172 extend beyond the recessed ledge 162 such that a ring-shaped blade is configured to fit between the protruding portion 158 and a portion of the alignment fitting 172. In other words, the alignment fitting 172 provides an orthogonal outer surface for containing a ring-shaped blade fit around the protruding portion 158.

The ink holder 150 is an embodiment of an integrally-formed piece that may be used in conjunction with a printing system to cyclically refill depressions in a printing plate. The ink holder 150 may serve as a compact and efficient adapter for containing ink within an ink cup liner and coupling with a mechanical force mechanism that directly applies pressure to keep the ink cup in contact with the printing plate. The ink holder 150 further includes components for attaching to a ring-shaped blade and fittings for connecting to a movement mechanism that moves the ink holder 150 relative to the printing plate.

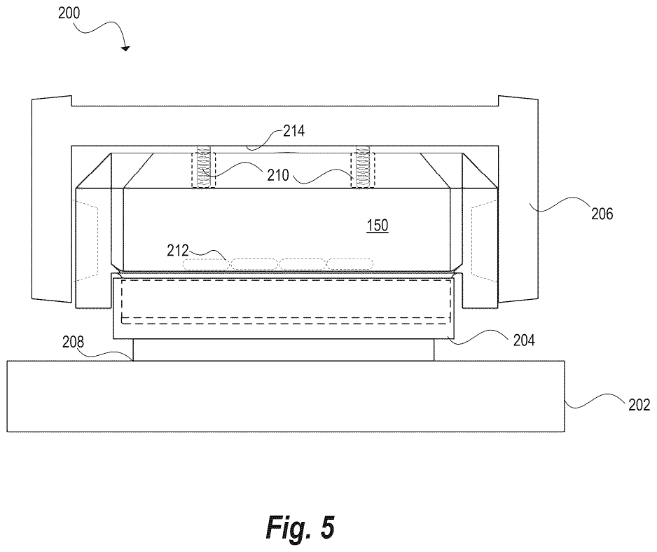

FIG. 5 is side view diagram of a printing system 200, consistent with the disclosure. The printing assembly 200 includes the ink holder 150. The printing system 200 further includes a printing plate 202, a blade 204, and support structure 206 of a movement mechanism. The ink holder 150, the blade 204 and a force mechanism, in combination, form an ink cup assembly of the printing system 200. The blade 204 is a ring-shaped component configured to fit around the protruding portion 158 of the ink holder 150. In some embodiments, a lip of an ink cup liner fits between the ink holder 150 and the blade 204. The blade 204 includes an edge 208 that is place in contact with a surface of the printing plate 202.

A movement mechanism including the support structure 206 is configured to move the ink holder 150 and blade 204 along the surface of the printing plate 202 between a first position and a second position. For example, the support structure 206 may be connected for movement by a motor or other automated system. In some embodiments, the support structure 206 may be moved manually.

A plurality of springs 210 are fit within the blind holes 170 of the ink holder 150 and provide the force mechanism to urge the ink holder 150 and the blade 204 toward the printing plate 202. In some embodiments, the system 200 further includes least one magnet 212 that contributes to holding the ink cup assembly to the printing plate 202 via an attraction force. The ink holder 150 is configured to be attached to the support structure 206 by the alignment fittings 172.

The support structure 206 may include a counteracting surface 214. The counteracting surface 214 may be configured to be positioned adjacent to and directly opposing the flat portion 166 of the pressure surface 164 of the ink holder 150. The springs 210 are configured to act as a force mechanism that presses off of the counteracting surface 214 and urges the ink holder 150 toward the printing plate 202.

The springs 210 may be selected to have characteristics (e.g., spring rate, size, etc.) such that the force applied to the ink holder 150 and to the blade 204 is calibrated to enable sliding motion of the ink cup assembly on the printing plate 202 while effectively scraping the ink from the surface of the printing plate 202 to leave ink only in the depressions in the printing plate 202. In an exemplary embodiment, the springs 210 have a spring rate of approximately 20-40 lbs./in. In a more particular embodiment, each spring 210 has a spring rate of approximately 27.3 lbs./in. The spring rate of each spring 210 may be selected based on other factors, including the number of springs used and the desired overall force to be applied to the ink holder 150.

The disclosed ink cup assembly helps to prevent printing errors such as stray marks, shadows, and smearing, while enabling use of the ink cup assembly with printing plates that do not include provide a sufficient attraction force for use of magnets alone as a force mechanism. Further, the compact structure of the disclosed ink holder enables adaptability to different types and setups of printing systems, selection of different sizes and types of blades, use with reusable or disposable ink cup liners, and selection of different force mechanisms.

Disclosed embodiments include a printing system for use in pad printing on golf balls. The printing system may be used in a printing process to apply ink to a golf ball via a printing pad to apply indicia to the golf ball. The process includes cyclically filling depressions in a printing plate, the depressions corresponding to a pattern that matches the indicia to be printed. For example, the printing process includes a step of spreading ink across the surface of a plate. The ink is then scraped back using a blade, which leaves ink in the depressions on the plate. Thinner evaporates from the ink lying in these depressions and the ink surface becomes tacky. As the pad passes over the depressions, ink will stick to the pad. As the pad lifts, it takes with it not only the tacky, adhering film, but also some of the more fluid ink underneath. This film of ink is carried to the target area on the dimpled golf ball surface. On the way, more of the thinner evaporates from the exposed surface of the ink on the silicone pad, and the ink surface facing away from the pad becomes tacky. As the pad is applied to the golf ball, the film of ink sticks to the ball surface and separates from the pad as it is raised. Disclosed embodiments of an ink holder may be used in the printing processes to cyclically refill the depressions formed in the plate, based on sliding movement on the plate as caused by a movement mechanism.

When numerical lower limits and numerical upper limits are set forth herein, it is contemplated that any combination of these values may be used. All patents, publications, test procedures, and other references cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those of ordinary skill in the art without departing from the spirit and scope of the invention. Accordingly, it is not intended that the scope of the claims appended hereto be limited to the examples and descriptions set forth herein, but rather that the claims be construed as encompassing all of the features of patentable novelty which reside in the present invention, including all features which would be treated as equivalents thereof by those of ordinary skill in the art to which the invention pertains.

1. A printing system, comprising:
a printing plate comprising a surface and a depression formed in the surface for receiving ink for printing on a golf ball;
an ink cup assembly configured to contact the surface of the printing plate and supply the depression with ink, the ink cup assembly comprising:
an ink holder comprising:
a first side comprising an open cavity;
a second, opposite side comprising a pressure surface, wherein the pressure surface comprises at least one blind hole; and
a perimeter wall between the first side and the second side; and
a force mechanism configured to hold the ink cup assembly in contact with the surface of the printing plate, wherein the force mechanism comprises at least one spring positioned in the at least one blind hole and configured to apply a predetermined force to the pressure surface of the ink holder; and
a movement mechanism configured to move the ink cup assembly between a first position on the printing plate and a second position on the printing plate while the ink cup assembly maintains contact with the surface of the printing plate, wherein the movement mechanism comprises a support structure comprising a counteracting surface, wherein the counteracting surface is adjacent to the pressure surface of the ink holder and the at least one spring is configured to act against the counteracting surface to apply the predetermined force to the pressure surface.

2. The printing system of claim 1, wherein the ink holder is comprises a body integrally formed as one piece, the body comprising the first side, the second side. and the perimeter wall, wherein the perimeter wall defines a height of the body.

3. (canceled)

4. The printing system of claim 1, wherein the open cavity is formed as a through hole that extends through an entire body of the ink holder, wherein the pressure surface surrounds the through hole.

5. The printing system of claim 1, wherein the open cavity is configured to receive an ink cup liner.

6. (canceled)

7. The printing system of claim 1, wherein the at least one spring comprises a plurality of springs and the at least one blind hole comprises a plurality of blind holes, each configured to receive one of the plurality of springs.

8. The printing system of claim 7, wherein the plurality of springs comprises at least four springs, and wherein the plurality of blind holes comprises at least four blind holes for receiving the at least four springs.

9. The printing system of claim 2, wherein the force mechanism further comprises at least one magnet that contributes to holding the ink cup assembly to the printing plate via an attraction force.

10. The printing system of claim 1, further comprising a steel ring configured to surround the open cavity of the ink holder.

11. The printing system of claim 2, wherein
the height of the body is less than 120 mm.

12. (canceled)

13. The printing system of claim 1, wherein the pressure surface comprises a flat portion and a chamfered portion surrounding the flat portion.

14. The printing system of claim 1, wherein the first side comprises a protruding portion surrounding the open cavity and a recessed ledge surrounding the protruding portion.

15. The printing system of claim 14, wherein the protruding portion comprises a plurality of recesses each configured to receive a magnet.

16. The printing system of claim 14, further comprising a circular ring configured to fit around the protruding portion,

17. The printing system of claim 16, wherein the perimeter wall comprises at least one alignment fitting extending in a height direction of the ink holder, the at least one alignment fitting configured to connect the ink holder to the support structure of the movement mechanism for movement of the ink holder on the printing plate.

18. The printing system of claim 17, wherein the at least one alignment fitting extends beyond the recessed ledge such that the circular ring is configured to fit between the protruding portion and the at least one alignment fitting.

19. The printing system of claim 18, wherein the at least one alignment fitting comprises two alignment fittings disposed on opposing sides of the ink holder.

20. The printing system of claim 2, wherein the body is formed integrally as one piece from a polymer material.

21. The printing system of claim 1, wherein the at least one blind hole has a depth of less than 25 mm,

22. The printing system of claim 2, wherein the at least one blind hole comprises a plurality of blind holes, and wherein the plurality of blind holes are equally spaced from each other and from a center point of the body on a circle.

23. The printing system of claim 22, wherein the circle has a radius between 5 and 60 mm.
